(19) United States
(12) Patent Application Publication
(10) Pub. No.: US 2026/0297470 A1
(43) Pub. Date: Oct. 1, 2026

(54) METHOD OF LAUNDERING FABRICS

(71) Applicant: THE PROCTER & GAMBLE COMPANY, Cincinnati, OH (US)

(72) Inventors: Amanda Georgiana BOWES, Newcastle upon Tyne (GB); Karel Jozef Maria DEPOOT, Anzegem (BE); Robby Renilde François KEULEERS, Sint-Amands (BE); Steven George PATTERSON, Washington (GB); Wouter WALRAVENS, Humbeek (BE)

(21) Appl. No.: 19/570,937

(22) Filed: Mar. 18, 2026

(30) Foreign Application Priority Data
Mar. 18, 2025 (EP) 25164514.9

(51) Int. Cl. C11D 17/04; C11D 1/29; C11D 1/72; C11D 1/83; C11D 3/12; C11D 3/33; C11D 3/36; C11D 3/37; C11D 3/386; C11D 3/42; C11D 3/43

(52) U.S. Cl. CPC C11D 17/043; C11D 1/29; C11D 1/72; C11D 1/83; C11D 3/122; C11D 3/33; C11D 3/364; C11D 3/3723; C11D 3/3788; C11D 3/3796; C11D 3/38618; C11D 3/38627; C11D 3/38636; C11D 3/42; C11D 3/43; C11D 2111/12

(57) ABSTRACT

A method of laundering a fabric in an automatic washing machine using a water-soluble unit dose article including a detergent composition and a water-soluble film, the detergent composition including a surfactant system including an anionic surfactant and a nonionic surfactant in a weight ratio of from 4:1 to 1:2 and a cleaning additive selected from the group consisting of a cleaning polymer, a zwitterionic polyamine, an enzyme system, a chelant, and a mixture thereof, the method including the steps of: a) delivering the water-soluble unit dose article to the washing machine; b) delivering water to the washing machine to release the detergent composition and to achieve a water/detergent dilution of from about 200 to about 700 ml water/g detergent, to create a wash liquor including from 400 to 700 ppm of total surfactant; c) exposing the fabric to the wash liquor resulting from step b; and d) optionally rinsing the fabric; and e) optionally drying the fabric.

### FIELD

The present disclosure relates to a method for washing fabrics in an automatic washing machine, a wash liquor and a water-soluble unit dose laundry detergent.

### BACKGROUND

The problem addressed herein is the need for a detergent formulation that maintains high cleaning efficacy while reducing the reliance on surfactants.

Maintaining or enhancing cleaning effectiveness while reducing surfactant levels poses several difficulties, including:
Grease and Oil Removal: Surfactants are particularly effective in emulsifying and removing greasy and oily substances. Developing a detergent that can efficiently tackle grease and oil while reducing surfactant content requires exploring novel approaches, such as incorporating specialized additives or employing synergistic ingredient combinations.
Non-greasy Soil Removal: Surfactants equally play a crucial role in loosening and removing non-greasy soils from surfaces. Reducing surfactant content without compromising cleaning efficacy requires identifying alternative cleaning mechanisms or innovative formulations that effectively tackle different types of dirt and stains.
Soil Dispersion: Surfactants contribute to the soil dispersion properties of detergents, aiding in the even distribution and suspension of soils. Lowering surfactant levels while maintaining appropriate soil suspension characteristics necessitates alternative ingredients or strategies to ensure effective product performance.
Stain Prevention and Whiteness Maintenance: Surfactants also play a role in preventing staining and maintaining the whiteness of fabrics. Reducing surfactant levels while still achieving stain prevention and preserving fabric appearance requires innovative solutions that address these aspects without compromising overall cleaning performance.

Finding a solution to these challenges is crucial to meet the increasing demand for sustainable cleaning products that minimize environmental impact without compromising on cleaning efficacy. The solution aims to develop a novel detergent composition, formulation, or cleaning mechanism that significantly reduces surfactant usage while maintaining or enhancing cleaning performance and overall whiteness across various fabrics and soil types.

It was surprisingly found that the method of the present disclosure provided good cleaning and whiteness results even with a reduced amount of surfactant.

### SUMMARY

According to the first aspect of the disclosure, there is provided a method for laundering fabric in an automatic washing machine that utilizes a specific formulation, characterized by the exclusive use of a single water-soluble unit dose article. This unit dose article comprises a detergent composition encapsulated within a water-soluble film, which is designed to dissolve in the wash process, thereby releasing the detergent components effectively.

### Key Features of the Method

Exclusive Use of One Unit Dose Article: The method is defined by the critical requirement of employing one and only one water-soluble unit dose article during the laundering process. This specification is essential for the following reasons:
Precise Control of Dosage: The use of a single unit dose ensures that the amount of detergent and cleaning additives used is accurately defined, facilitating consistent and effective cleaning performance. This precision minimizes the likelihood of variations in cleaning efficacy that could arise from using multiple articles.
User Convenience: Limiting the method to one water-soluble unit dose article simplifies the laundering process for users. It eliminates confusion regarding the number of articles to be used, thus enhancing user experience and compliance with the recommended laundering procedure.
Optimized Performance: The formulation is tailored to work optimally with a single unit dose, ensuring that the dilution and resultant concentration of active ingredients in the wash liquor remain within the specified parameters. This enhances the overall effectiveness of the laundering process.
Environmental Benefits: Utilizing a single water-soluble unit dose article contributes to reduced packaging waste and promotes sustainability, aligning with environmental standards and consumer preferences.
Detergent Composition: The water-soluble unit dose article comprises a detergent formulation that includes a surfactant system consisting of both anionic and nonionic surfactants in a specified weight ratio. This combination is designed to enhance cleaning efficiency and fabric care.
Method Steps: The method comprises several distinct steps:
Step a: Delivering the water-soluble unit dose article to the washing machine ensures that the detergent composition is introduced into the wash environment.
Step b: The addition of water to the washing machine is crucial for releasing the detergent composition. The specified water-to-detergent dilution ratio of 200 to 700 ml of water per gram of detergent, or 250 to 650 ml of water per gram of detergent, or 300 to 600 ml of water per gram of detergent, the ratio is designed to create a wash liquor with a total surfactant concentration of 400 to 700 ppm, or 450 to 650 ppm, or 400 to 600 ppm, which is optimal for effective cleaning.
Step c: Exposing the fabric to this wash liquor facilitates the cleaning action of the detergent and cleaning additives.
Steps d and e: The optional rinsing and drying steps provide additional care for the fabric, ensuring that any residual detergent is removed and the fabric is appropriately finished.

In conclusion, the method of laundering fabric as outlined in this patent claim is distinctively characterized by the exclusive use of a single water-soluble unit dose article. This specific requirement enhances the method's effectiveness, user-friendliness, and environmental sustainability, distinguishing it from existing laundering methods.

The method provides good cleaning and whiteness in spite of the low level of surfactant used.

According to the second and third aspects of the disclosure there are provided a wash liquor and a water-soluble unit dose laundry detergent suitable for use in the method of the disclosure. The elements of the method described in relation to the first aspect of the disclosure apply mutatis mutandis to the second and third aspects of the disclosure.

### DETAILED DESCRIPTION

The present disclosure is directed to a method of laundering a fabric. The method takes place in an automatic washing machine using a water-soluble unit dose detergent article. The method involves using a low level of surfactant and still provides good cleaning and whiteness.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

The method of washing, unit-dose article and detergent composition are explained in more detail herein below.

“Standard temperature and pressure” generally refer to 25° C. and 1 atmosphere. Standard temperature and pressure may also be referred to as “ambient conditions.” Unless indicated otherwise, parts are by weight, temperature is in ° C., and pressure is at or near atmospheric.

### Method of Laundering

The method of the present disclosure takes place in an automatic washing machine using a water-soluble unit dose article.

The water-soluble unit dose article is preferably added to the drum of the machine. Alternatively, the water-soluble unit dose article may be added to the drawer of the automatic washing machine. Alternatively, it may be dispensed from a storage receptacle into the washing machine, preferably into the drum. Those skilled in the art will be aware of relevant storage receptacles.

Those skilled in the art will be aware of suitable automatic washing machines. Those skilled in the art will also be aware that automatic washing machines comprise a drum and a drawer and will be able to locate said drum or drawer and add both the fabric and the water-soluble unit dose article thereto accordingly.

By fabric we preferably mean a textile or cloth comprising a network of natural and/or artificial fibers. Those skilled in the art will be aware of suitable fabric. Preferably the fabric is one that is worn by consumers such as clothing. Preferably the fabric comprises at least one stain or soil to be removed.

The method comprises the step of washing the fabric in an automatic washing machine. The wash process comprises a wash step and optionally but preferably one or more rinse steps, preferably the rinse step(s) follow the wash step.

The wash step may take between 5 minutes and 50 minutes, alternatively between 5 minutes and 40 minutes, alternatively between 5 minutes and 30 minutes, alternatively between 5 minutes and 20 minutes, alternatively between 6 minutes and 18 minutes.

The wash step may comprise the addition of between 5 L and 40 L, preferably between 10 L and 40 L, more preferably between 10 L and 30 L, most preferably between 10 L and 20 L of water to the drum of the automatic washing machine.

The temperature of the water in the wash step may be between 10° C. and 45° C., preferably between 15° C. and 35° C. Alternatively but less preferred the temperature of the water in the wash step may exceed 45° C. up to a temperature as high as 95° C.

The automatic washing process may comprise at least one rinse step. The automatic washing machine process may comprise a final rinse step, preferably wherein the drum of the automatic washing machine rotates at a speed of between 500 rpm and 2000 rpm during the final rinse step.

The specific steps in the present method can provide a more environmentally friendly fabric wash process. The first step of selecting a water-soluble unit dose article overcomes the issue of under-dosing, which could lead to having to re-wash the fabric, or over-dosing of the detergent composition. Also the step of specifically selecting a low level of surfactant can also help to have a more environmentally friendly fabric wash process.

Preferably the wash process is selected from short wash process, cold wash process and quick wash process. Wash processes are also trending to reduce water consumption. Those skilled in the art will know how to select a wash cycle having the properties required by the present disclosure.

Preferably, between 4 kg and 15 kg, more preferably between 5 kg and 12 kg, most preferably between 6 kg and 8 kg of fabric is added to the wash machine to be washed.

### Water-Soluble Unit Dose Article

The present disclosure details a water-soluble unit dose article comprising a water-soluble film and a detergent composition, preferably a liquid composition. The water-soluble film and the detergent composition are described in more detail below.

The water-soluble unit dose detergent article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments, or even at least four compartments. The compartments may be arranged in superposed orientation, i.e. one positioned on top of the other. In such an orientation the unit dose article will comprise at least three films, top, one or more middle, and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. Wherein the unit dose article comprises at least four compartments, three of the compartments may be smaller than the fourth compartment, and preferably the smaller compartments are superposed on the larger compartment. The superposed compartments preferably are orientated side-by-side. The unit dose article may comprise at least four compartments, three of the compartments may be smaller than the fourth compartment, and preferably the smaller compartments are superposed on the larger compartment. The superposed compartments preferably are orientated side-by-side.

In a multi-compartment orientation, the detergent composition according to the present disclosure may be comprised in at least one of the compartments. It may for example be comprised in just one compartment, or may be comprised in two compartments, or even in three compartments, or even in four compartments. Alternatively, the detergent composition according to the disclosure may be split over different compartments, such that the individual components get combined in the wash solution upon use.

Each compartment may comprise the same or different compositions. The different compositions could all be in the same form, or they may be in different forms.

The water-soluble unit dose article may comprise at least two internal compartments, wherein the laundry detergent composition is comprised in at least one of the compartments, preferably wherein the unit dose article comprises at least three compartments, wherein the detergent composition is comprised in at least one of the compartments.

The water-soluble unit dose article may comprise from 8 to 40, preferably from 10 to 30, more preferably from 12 to 20 or from 12 to 25 grams of detergent composition.

The water-soluble unit dose article may comprise from 8 to 40, preferably from 10 to 30, more preferably from 12 to 20 or from 12 to 25 ml of detergent composition.

### Water-Soluble Film

The film of the present disclosure is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:
5 grams±0.1 gram of film material is added in a pre-weighed 3 L beaker and 2 L*5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Preferably, the water-soluble film comprises polyvinylalcohol polymer, preferably wherein the polyvinylalcohol polymer comprises polyvinyl alcohol homopolymer or polyvinyl alcohol copolymer, or a mixture thereof, preferably a blend of polyvinylalcohol homopolymers and/or polyvinylalcohol copolymers, preferably wherein the polyvinylalcohol copolymers are selected from sulphonated and carboxylated anionic polyvinylalcohol copolymers especially carboxylated anionic polyvinylalcohol copolymers, most preferably wherein the polyvinylalcohol polymer comprises a blend of a polyvinylalcohol homopolymer and a carboxylated anionic polyvinylalcohol copolymer or a blend of polyvinylalcohol homopolymers. Alternatively, the water-soluble film may comprise a single polyvinylacohol polymer, preferably a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area. The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 ppm.

Preferably, the water-soluble film or water-soluble unit dose article or both are coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

### Detergent Composition

The detergent composition may be in the form of free-flowing powder, a liquid, a compacted solid, a gel or a mixture thereof.

The detergent composition may be in the form of a free-flowing powder. Such a free-flowing powder may have an average particle size diameter of between 100 microns and 1500 microns, preferably between 100 microns and 1000 microns, more preferably between 100 microns and 750 microns. Those skilled in the art will be aware of standard techniques to measure particle size. The detergent composition may be a free-flowing laundry detergent composition.

The detergent composition is preferably in liquid form. In relation to the liquid detergent composition of the present disclosure, the term ‘liquid’ encompasses forms such as dispersions, gels, pastes and the like. The liquid composition may also include gases in suitably subdivided form. However, the liquid composition excludes forms which are non-liquid overall, such as tablets or granules.

The detergent composition may be a liquid laundry detergent composition. The term ‘liquid laundry detergent composition’ refers to any laundry detergent composition comprising a liquid capable of wetting and treating fabric e.g., cleaning clothing in a domestic washing machine.

The laundry detergent composition comprises a surfactant system and a cleaning additive selected from the group consisting of a cleaning polymer, a zwitterionic polyamine, an enzyme system, a chelant, and a mixture thereof.

The surfactant is preferably selected from anionic surfactant, non-ionic surfactant, or a mixture thereof. Preferably, the surfactant system comprises a non-soap surfactant system wherein the non-soap surfactant system comprises non-soap anionic surfactant and nonionic surfactant. Preferably, the detergent composition comprises between 10% and 70%, alternatively between 15% and 65%, alternatively between 20% and 60% by weight of the detergent composition of the surfactant. Preferably, the detergent composition comprises between 10% and 60%, alternatively between 12.5% and 55%, alternatively between 15% and 50% by weight of the detergent composition of the non-soap surfactant. Preferably, the composition is a laundry composition. Preferably, the composition is a liquid composition and more preferably the composition is liquid laundry detergent composition. The weight ratio of anionic surfactant to nonionic surfactant is from 4:1 to 1:2, preferably from 3.5:1 to 1:1, more preferably from 3:1 to 2:1. Preferably, the weight ratio of non-soap anionic surfactant to nonionic surfactant is from 3:1 to 1:2, preferably from 2.5:1 to 1:1, more preferably from 2:1 to 1.2:1. For surfactant weight % or weight ratio calculation the weight of the neutralizing counterion in the case of anionic surfactants is not taken into account, e.g. for soap or non-soap anionic surfactants solely the weight of the surfactant anion is considered when calculating the soap or non-soap anionic surfactant weight % or soap or non-soap anionic surfactant to nonionic surfactant weight ratio.

Preferably, the anionic non-soap surfactant comprises a sulfonate surfactant, alkoxylated alkyl sulphate, or a mixture thereof. Preferably, the sulfonate surfactant is a linear alkylbenzene sulphonate. Preferably, the alkoxylated alkyl sulphate is an ethoxylated alkyl sulphate.

Preferably, the composition comprises between 5% and 50%, preferably between 10% and 45%, most preferably between 15% and 40%, by weight of the composition of the anionic surfactant.

Preferably, the composition comprises between 5% and 45%, preferably between 7.5% and 40%, most preferably between 10% and 35%, by weight of the composition of the non-soap anionic surfactant.

Preferably, the non-soap anionic surfactant comprises linear alkylbenzene sulphonate and alkoxylated alkyl sulphate, wherein the ratio of linear alkylbenzene sulphonate to alkoxylated alkyl sulphate preferably the weight ratio of linear alkylbenzene sulphonate to ethoxylated alkyl sulphate is from 1:2 to 9:1, preferably from 1:1 to 7:1, more preferably from 1:1 to 5:1, even more preferably from 1:1 to 4:1. Alternatively the non-soap anionic surfactant can consist of linear alkylbenzene sulphonate. Alternatively the non-soap anionic surfactant can comprise unalkoxylated alkyl sulphate and linear alkylbenzene sulphonate. The alkoxylated or unalkoxylated alkyl sulphate can be derived from a synthetic alcohol or a natural alcohol, or from a blend thereof, pending the desired average alkyl carbon chain length and average degree of branching. Preferably, the synthetic alcohol is made following the Ziegler process, OXO-process, modified OXO-process, the Fischer Tropsch process, Guerbet process or a mixture thereof. Preferably, the naturally derived alcohol is derived from natural oils, preferably coconut oil, palm kernel oil or a mixture thereof.

Preferably, the anionic surfactant comprises between 0.5% and 30%, preferably between 1.5% and 25%, more preferably between 2% and 20%, even more preferably between 3% and 15%, most preferably between 4% and 12% by weight of the composition of soap, preferably a fatty acid salt, more preferably an amine neutralized fatty acid salt, wherein preferably the amine is an alkanolamine more preferably selected from monoethanolamine, diethanolamine, triethanolamine, mono-isopropylamine, di-isopropylamine, tri-isopropylamine, or a mixture thereof, more preferably monoethanolamine.

Preferably, the detergent composition comprises between 1% and 30%, preferably between 3% and 25%, most preferably between 5% and 20% by weight of the detergent composition of a non-ionic surfactant. The non-ionic surfactant is preferably selected from alcohol alkoxylate, Ziegler-synthesized alcohol alkoxylate, an oxo-synthesized alcohol alkoxylate, Guerbet alcohol alkoxylates, alkyl phenol alcohol alkoxylates, or a mixture thereof.

The detergent comprises up to 15% by weight of the composition of water, preferably between 5% and 15%, more preferably between 7% and 15% by weight of the detergent composition of water.

Preferably, the detergent composition comprises between 5% and 45%, preferably between 10% and 35% by weight of the laundry detergent composition of a non-aqueous organic solvent, preferably wherein the non-aqueous organic solvent is selected from 1,2-propanediol, dipropylene glycol, tripropyleneglycol, glycerol, sorbitol, polyethylene glycol, ethoxylated glycerin or a mixture thereof. Preferably the non-aqueous organic solvent comprises 1,2-propanediol and glycerol, more preferably wherein the 1,2-propanediol and glycerol are in a weight ratio of from 1:3 to 12:1, preferably of from 1:2 to 9:1, more preferably from 1:1 to 6:1. The laundry composition preferably comprises less than 1% preferably less than 0.5% by weight of the composition of ethanol, most preferably the laundry composition is free of ethanol.

### Cleaning Polymer

The detergent composition can comprise a cleaning polymer and the cleaning polymer comprises at least one polymer and preferably at least two polymers selected from the group consisting of an amphiphilic graft polymer, a modified polyamine polymer, a polyester soil release polymer and a polysaccharide-based polymer.

Preferably, the wash liquor resulting from step b. comprises from 100 to 300 ppm, preferably from 150 to 300 ppm of the cleaning polymer. More preferably the non-soap surfactant system and the cleaning polymer are present in the wash liquor resulting from step b. in a weight ratio of from 1.5:1 to 8:1, preferably from 2:1 to 6:1.

### Amphiphilic Graft Polymer

The wash solution preferably comprises from 50 to 150 ppm preferably from 75 to 125 ppm of an amphiphilic graft polymer preferably an amphiphilic graft co-polymer.

The graft polymer comprises a backbone (A) as a graft base and polymeric sidechains (B) grafted on the backbone (A). Said backbone (A) comprises structural units obtainable by polymerization of at least one alkylene oxide monomers selected from the group of ethylene oxide, 1,2-propylene oxide, 1,2-butylene oxide, 2,3-butylene oxide, 1,2-pentene oxide or 2,3-pentene oxide. Said polymeric sidechains (B) are obtainable by polymerization of at least one vinyl ester monomer. The graft polymers are known as effective soil suspension polymers for hydrophobic stains (such as greasy, body soil) and hydrophilic stains (such as clay and other particulate stains), surfactant boosters, soil release agents, and sometimes as dye transfer inhibitors.

Suitable graft polymer comprises polyethylene glycol backbone (A) as a graft base, and at least one polymeric sidechain (B) grafted on the polyethylene glycol backbone (A), wherein the polymeric sidechain comprises polyvinyl acetate structural units and optionally polyvinyl alcohol structural units. One preferred graft polymer of this type is Sokalan HP22 available from BASF. Other preferred graft polymers of this type are described in WO2023019153, wherein the molecular weight of the polyethylene glycol backbone Mn in g/mol is within 500 to 5000, these polymers have improved biodegradation profiles.

Suitable graft polymers are also described in WO2007/138053 as amphiphilic graft polymers based on water-soluble polyalkylene oxides (A) as a graft base and sidechains formed by polymerization of a vinyl ester component (B), said polymers having an average of <one graft site per 50 alkylene oxide units and mean molar masses M of from 3000 to 100000. One specific preferred graft polymer is polyvinyl acetate grafted polyethylene oxide copolymer having a polyethylene oxide as graft base and multiple polyvinyl acetate side chains, wherein, the molecular weight of the polyethylene oxide backbone is about 6000 and the weight ratio of the polyethylene oxide to polyvinyl acetate is about 40 to 60 and no more than 1 grafting point per 50 ethylene oxide units. The most preferred polymer of this type is available from BASF as Sokalan PG101.

Suitable graft polymer also include graft polymer comprising a block copolymer backbone (A) as a graft base, wherein said block copolymer backbone (A) is obtainable by polymerization of at least two monomers selected from the group of ethylene oxide, 1,2-propylene oxide, 1,2-butylene oxide, 2,3-butylene oxide, 1,2-pentene oxide or 2,3-pentene oxide, wherein the number (x) of individual blocks within the block copolymer backbone (A) is an integer, wherein x is from 2 to 10 and preferably 3 to 5, and (B) polymeric sidechains grafted onto the block copolymer backbone, wherein said polymeric sidechains (B) are obtainable by polymerization of at least one vinyl ester monomer. Suitable graft polymers of this type are described in WO2021/160795 and WO2021/160851, these polymers have improved biodegradation profiles.

Suitable graft polymers may comprise a backbone (A) that contains alternative structural units which are different from structural unit derived from alkylene oxide monomer, such as structural units derived from lactone and/or hydroxy acid. Suitable graft polymer may comprise polymeric sidechains (B) obtainable by polymerization of at least one vinyl ester monomer (B1) and at least one alternative vinyl monomer (B2) which is different from (B1). The alternative vinyl monomer (B2) is selected from acrylic or methacrylic acid and ester thereof; N-vinyl lactam such as N-vinylpyrrolidone, N-vinylpiperidone, N-vinylcaprolactam; 1-vinylimidazole or its derivatives such as alkyl-substituted derivatives of 1-vinylimidazole such as 2-methyl-1-vinylimidazole; and any combination thereof. Preferred graft polymers are described in WO2020005476 as dye transfer inhibitors. More examples of this type are described in WO2022/263354, WO2024/129520, WO2024/126267, WO2024/126271, WO2024/126270, WO2024/126268, WO2024/126267 and WO2024/017797.

### Modified Polyamine Polymer

The wash solution preferably comprises from 35 to 100 ppm preferably from 50 ppm to 75 ppm of the modified polyamine preferably an alkoxylated polyamine and/or an alkoxylated polyalkyleneimine polymer.

The modified polyamine comprises a polyamine core structure and a plurality of alkoxylate groups attached to the core structure. The polyamine core structure includes polyalkyleneimine, and linear or branched oligoamine.

The polyamine core structure and the alkoxylate groups attached to the core structure can be further derivatized. For example, the polyamine core structure can be further partly or completely quaternized with C₁-C₃₀ linear or branched alkyl, more preferably C₁-C₁₀ or even C₁-C₅ linear or branched alkyl, most preferably methyl. The alkoxylate group can be further sulphated, sulphonated and/or substituted with an amino functional group. The alkoxylate groups attached to the core structure can comprises alternative structural units which are different from structural unit derived from alkylene oxide monomer, such as structural units derived from lactone and/or hydroxy acid.

Suitable modified polyamine dispersing agent includes ethoxylated polyethyleneimine (EPEI). EPEI are effective dispersing agent for hydrophilic stains, especially hydrophilic particulate stain such as clay. Preferably, the EPEI has a polyethyleneimine backbone of weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, preferably about 600. The ethoxylation chains within the EPEI have on average 5 to 40, preferably 10 to 30, more preferably 15 to 25, even more preferably 18 to 22, most preferably about 20 ethoxy units per ethoxylation chain. The EPEI may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol. A preferred example is polyethyleneimine core (with average molecular weight about 600 g/mol) ethoxylated to 20 EO groups per NH. Suitable EPEI this type includes Sokalan HP20 available from BASF, Lutensol FP620 from BASF. Examples of available polyethyleneimine ethoxylates also include those prepared by reacting ethylene oxide with Epomine SP-006 manufactured by Nippon Shokubai. Another preferred EPEI comprises polyethyleneimine has an average molecular weight (Mw) ranging from 1800 to 5000 g/mol (prior to ethoxylation), and the polyoxyethylene side chains have an average of from 25 to 40 ethoxy units per side chain bonded to the polyethyleneimine backbone. Such EPEI is described in WO2020/030760 and WO2020/030469.

Other suitable modify polyamines include those disclosed in WO2021239453.

Suitable modified polyamine dispersing agent includes amphiphilic alkoxylated polyalkyleneimine polymer. Suitable amphiphilic alkoxylated polyalkyleneimine polymer is described in WO2009/061990, WO2006/108857 and WO2021061774 . . . . A preferred alkoxylated polyalkyleneimine polymer is polyethyleneimine (MW=600) modified with 24 ethoxylate groups per —NH and 16 propoxylate groups per —NH. Another preferred alkoxylated polyalkyleneimine polymer is polyethyleneimine (MW=600) modified with 10 ethoxylate groups per —NH and 7 propoxylate groups per —NH. Another preferred alkoxylated polyalkyleneimine polymer of this type includes Sokalan HP30 Booster available from BASF.

### Polyester Soil Release Polymer (Polyester SRP)

The wash solution preferably comprises from 8 to 30 ppm preferably from 12 to 25 ppm of a polyester soil release polymer, preferably of a polyester terephtalate.

In the washing process, polyester SRPs can deposit on fibers, particularly synthetic fibers such as polyester, which change the surface properties of fabric and deliver various benefit, such as reduced soil deposition onto fabric during wash and wear; reduced adhesion of microorganisms and allergens onto fabric; easier soil removal from fabrics which treated with soil release polymer in previous wash; reduced malodor; improved wicking properties.

The polyester SRP comprises at least one structural unit (A), at least one structural unit (B) and/or structural unit (C)

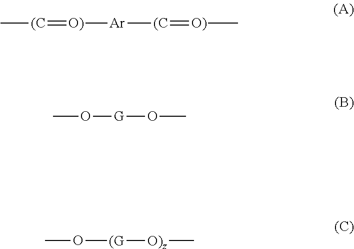

wherein,
Ar is a substituted aromatic ring selected from di-substituted benzene ring (—C₆H₄—), di-substituted furan ring (—C₄H₂O—), and di-substituted pyridine ring (—C₅H₃N—); preferably di-substituted benzene ring (—C₆H₄—).
G is C₂-C₁₂ alkylene, preferably C₂-C₆ alkylene, more preferably each independently selected from (C₂H₄) and (C₃H₆)
z is a molar average number from 2 to 200, preferably from 2 to 100, more preferably from 2 to 60,

Preferably, structural unit (A) has structure of (A-1) to (A-3). More preferably, structural unit (A) has structure of (A-1) and/or (A-2). More preferably, structure unit (A) has a structural of (A-1).

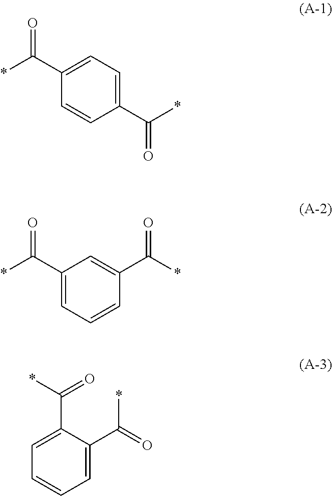

Typically, (A-1) is derived from terephthalic acid and/or derivatives thereof. (A-2) is derived from isophthalic acid and/or derivatives thereof. (A-3) is derived from phthalic acid and/or derivatives thereof. The “derivatives thereof” comprises, without limitation, salts, esters, diesters, and/or anhydrides. Preferred ester and diester here include methyl ester, and ethyl ester.

Preferably, structural unit (B) is derived from ethylene glycol, propylene glycol.

Preferably, structural unit (C) is derived from polyethylene glycol such as PEG200, PEG300, PEG550, PEG750, PEG1000, PEG1500, PEG2000, PEG2500, PEG3000, PEG3500, PEG4000, and PEG4500, and poly(ethylene glycol) monoalkyl ethers such as poly(ethylene glycol) monomethyl ethers including mPEG200, mPEG300, mPEG550, mPEG750, mPEG1000, mPEG1500, mPEG2000, mPEG2500, mPEG3000, mPEG3500, mPEG4000, and mPEG4500.

One type of preferred polyester SRPs are nonionic polyester SRP. A particular preferred nonionic polyester SRP has a structure according to formula below:

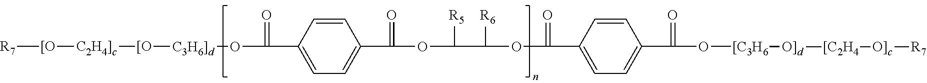

wherein:
R₅ and R₆ is independently selected from H or CH₃. More preferably, one of the R₅ and R₆ is H, and another is CH₃.
c, d are, based on molar average, a number independently selected from 0 to 200, where the sum of c+d is from 2 to 400,
   More preferably, d is from 0 to 50, c is from 1 to 200,
   More preferably, dis 1 to 10, c is 5 to 150,
R₇ is C₁₋₄ alkyl and more preferably methyl,
n is, based on molar average, from 1 to 50.

One example of most preferred above suitable terephthalate-derived nonionic SRP has one of the R₅ and R₆ is H, and another is CH₃; d is 0; c is from 5-100 and R₇ is methyl, and n is from 3-10.

Other suitable terephthalate-derived polyester SRP are described in patent WO2014019903, WO2014019658 and WO2014019659. The end capping group of these SRPs are selected from

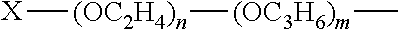

wherein X is C₁-C₄ alkyl and preferably methyl, the —(OC₂H₄) groups and the —(OC₃H₆) groups are arranged blockwise and the block consisting of the —(OC₃H₆) groups is bound to a COO group, n is based on a molar average a number of from 40 to 50, m is based on a molar average a number of from 1 to 10 and preferably of from 1 to 7.

Another type of preferred polyester SRPs are anionic polyester SRP which comprises one or more anionic structural units. Preferred anionic structural unit has a structure of (D).

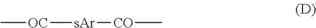

wherein, sAr is 1,3-substituted phenylene substituted in position 5 with —SO₃M; M is a counterion selected from Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

Suitable anionic polyester SRP are described in EP3222647, EP1966273B1.

Other suitable anionic SRPs are described in WO2022/167655, US20230406999, WO2024/032573, WO2024/094803, WO2024/094800, WO2024/094802, these polymers may have improved biodegradation profiles.

The composition may comprise nonionic SRPs and anionic SRPs.

Polyester SRPs may be available or convert into different forms, include powder, particle, liquid, waxy or premix. In some embodiment, other materials (for example, water, alcohol, other solvents, salt, surfactant, etc.) are needed to convert the polyester soil release polymer into different forms mentioned above, the wt % of active soil release polymer in the powder, particle, liquid, waxy or premix is in the range from 10% to 100%, for example 15%, 20%, 40%, 60%, 70%, 80%, 90%, 95%, 100%. Useful soil release polymer premix examples are described in EP351759 and WO2022100876. When the soil release polymers exist in liquid or premix from, the premix maybe transparent or opaque, white or slightly yellowish. Premix in opaque maybe use to provide an opaque appearance for the finish product or part of the finish product.

The polyester may or may not be biodegradable, preferred soil release polymers are readily biodegradable.

Example of suitable soil release polymers include TexCare® series supplied by Clariant, including nonionic soil release polymers Texcare® SRN 100, SRN 170, SRN 170 C, SRN 170 Terra, SRN 172, SRN 240, SRN 260, SRN 260 life, SRN 260 SG Terra, SRN UL50, SRN 300, SRN 325; and anionic soil release polymers TexCare® SRA 100, SRA 300, SRA300 F. Example of suitable soil release polymers also include REPEL-O-TEX® line of polymers supplied by Rhodia/Solvay, including nonionic soil release polymer REPEL-O-TEX® Crystal, Crystal PLUS, Crystal NAT, SRP6; and anionic soil release polymer REPEL-O-TEX® SF-2. Other example of commercial soil release polymers also includes WeylClean® series of soil release polymers supplied by WeylChem, including nonionic soil release polymers WeylClean® PLN1, PLN2; and anionic soil release polymers WeylClean® PSA1.

### Polymers Based on Polysaccharide

Polysaccharides are the most abundant carbohydrates in nature and serve a variety of functions, such as energy storage or as components of plant cell walls. Because of their availability, versatility and biodegradability, polysaccharides are extensively used for packaging, food, pharmaceutical, and consumer goods industries as sustainable and renewable materials.

Typically, natural polysaccharide without further chemical modification only delivers limited performance in fabric and home products, certain chemical modifications are required for polysaccharide to deliver stronger performance. Various polysaccharides have proven to be useful starting material to make polymers for fabric and home care products, including cellulose, starch, guar, dextran, polyglucan, chitin, curdlan, xylose, Inulin, pullulan, locust bean gum, cassia gum, tamarind gum (xyloglucan), xanthan gum, amylose, amylopectin, scleroglucan and mixtures thereof.

The most common type of modified polysaccharide is modified cellulose.

Modified cellulose polymers include anionic modified cellulose polymers which been modified with functional groups that contain negative charge. Suitable anionic modified cellulose polymers include carboxyalkyl cellulose, such as carboxymethyl cellulose. In one preferred embodiment, the carboxymethyl cellulose has a degree of carboxymethyl substitution of from about 0.5 to about 0.9 and a molecular weight from about 80,000 Da to about 300,000 Da. Suitable carboxymethylcellulose is described in WO2011/031599 and WO2009/154933. Suitable carboxymethylcellulose include Finnfix® series sold by CP Kelco or Nouryon, which include Finnfix® GDA, a hydrophobically modified carboxymethylcellulose, e.g., the alkyl ketene dimer derivative of carboxymethylcellulose sold under the tradename Finnfix® SH1, or the blocky carboxymethylcellulose sold under the tradename Finnfix® V. Other suitable anionic modified cellulose polymers include sulphoalkyl group which described in WO2006117056, sulfoethyl cellulose which described in WO2014124872.

Modified cellulose polymers also include nonionic modified cellulose polymers which been modified by functional group that does not contain any charge. Suitable nonionic modified cellulose polymers include alkyl cellulose, hydroxyalkyl cellulose, hydroxyalkyl alkylcellulose, alkylalkoxyalkyl cellulose. Suitable nonionic modified cellulose polymers also include nonionic cellulose carbamates which described in WO2015/044061; nonionic 6-desoxy-6-amino-celluloses derivative which described in US20180346846. Example of alkyl cellulose include methyl cellulose (MC), ethyl cellulose (EC), etc. Suitable ethyl cellulose are sold under tradename Ethocel™ by Dow Chemicals, DuPont, or IFF. Example of hydroxyalkyl cellulose include hydroxyethyl cellulose (HEC) and hydroxypropyl cellulose (HPC). Suitable HEC are sold under tradename Natrosol™ hydroxyethylcellulose by Ashland, such as Natrosol™ 250 with different grade available which has a total molar substitution (MS) of 2.5. Suitable HEC are also sold under tradename CELLOSIZE™ Hydroxyethyl Cellulose by Dow Chemicals. Suitable HPC are sold under tradename Klucel™ by Ashland. Example of hydroxyalkyl alkylcellulose include hydroxypropyl methylcellulose (HPMC), suitable HPMC are sold under tradename Methocel™ with different grade available by Dow Chemicals, DuPont or IFF, and under tradename Benecel™ by Ashland.

Another common type of modified polysaccharide is modified guar. Similar to modified cellulose, modified guar can be nonionic modified and anionic modified. Suitable nonionic modified guar includes hydroxypropyl guar, such as N-Hance™ HP40 and HP40S guar available from Ashland. Suitable example of modified guar also include carboxymethyl hydroxypropyl guar (CMHPG) which is anionic and nonionic modified, such as Galactasol™ available from Ashland. Other nonionic and/or anionic modified guar include for example Jaguar® HP 105 (Hydroxypropyl Guar gum), Jaguar® SOFT and HP-120 COS (Carboxymethyl Hydroxypropyl Guar Gum).

Other suitable polysaccharide polymers also include those based on inulin. Example of modified inulin include carboxymethyl group modified inulin (CMI), suitable CMI are Carboxyline series sold by Cosun Beet Company, including Carboxyline 25-40D, Carboxyline 25 D Powder, Carboxyline 20 LS D Powder, Carboxyline 25, Carboxyline 25-30 UP.

Suitable modified polysaccharide polymers also include polymers based on other polysaccharide, such as xylose carbamates as described in US20210115358; carboxy or sulfo-alkylated pullulan as described in WO2019243072; carboxy- or sulfo-alkylated chitosan as described in WO2019/243108 and WO2021156093.

### Zwitterionic Polyamines

Preferably, the wash liquor resulting from step b. comprises from 0 to 150 ppm, more preferably from 50 to 125 ppm of the zwitterionic polyamine.

A particular preferred zwitterionic polyamine is available from BASF as Lutensit Z96 polymer (zwitterionic hexamethylene diamine according to below formula: 100% quaternized and about 40% of the polyethoxy (EO₂₄) groups are sulfonated).

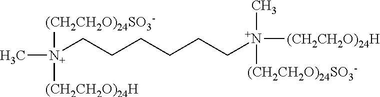

Another preferred zwitterionic polyamine is Sokalan HP96, available from BASF.

Another suitable zwitterionic polyamine is amphoterically-modified oligopropyleneimine ethoxylates as described in WO2021239547.

Preferably, the detergent composition comprises an adjunct ingredient selected from the group comprising builders, perfumes, enzymes, citrate, bleach, bleach catalyst, dye, hueing dye, brightener, fabric care polymers including cationic hydroxyethyl celluloses, cationic guar gums and cationic polyglucans, surfactant, solvent, dye transfer inhibitors, chelant, encapsulated perfume, polycarboxylates, structurant, pH trimming agents, anti-oxidants including Ralox 35, anti-foam agent, and mixtures thereof.

Preferably, the detergent composition comprises an enzyme system. The enzyme system comprise enzymes selected from the group comprising hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, xyloglucanases, mannanases and amylases, nuclease, pectate lyases, hexosaminidase, or mixtures thereof, preferably a further enzyme selected from the group comprising proteases, amylase, cellulase, lipases, xyloglucanases, mannanases, nucleases, pectate lyases, hexosaminidase, and mixtures thereof. Preferably, the wash liquor resulting from step b. comprises from 2 to 10 ppm on active protein basis of the enzyme system and the enzyme system preferably comprises two or more enzymes selected from the group consisting of protease, metalloprotease, amylase, cellulase, lipase, hexosaminidase, DNA'ase, pectate lyase and xyloglucanase.

### Chelants

Preferably, the wash liquor resulting from step b. comprises from 50 to 200 ppm, more preferably from 50 to 150 ppm, especially from 50 to 100 ppm of the chelant.

Preferably the chelant is selected from aminocarboxylate chelants, aminophosphonate chelants, or a mixture thereof.

Preferably, the detergent composition has a pH between 5 and 10, more preferably between 6 and 8.9, most preferably between 7 and 8, wherein the pH of the detergent composition is measured as a 10% weight product concentration in demineralized water at 20° C.

When liquid, the liquid detergent composition, preferably a liquid laundry detergent, may be Newtonian or non-Newtonian. Preferably, the laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

A preferred wash liquor resulting from step b. comprises:
i. from 100 to 300 ppm of the cleaning polymer;
ii. optionally from 40 to 150 ppm, preferably from 50 to 125 ppm of the zwitterionic polyamine, preferably a modified hexamethylenediamine;
iii. from 2 to 5 ppm on active protein basis of the enzyme system; and
iv. from 50 to 100 ppm of the chelant.

Another preferred wash liquor resulting from step b. comprises:
i. from 8 to 30 ppm, preferably from 12 to 25 ppm of a polyester terephthalate;
ii. from 50 to 150 ppm, preferably from 75 to 125 ppm of an amphiphilic graft co-polymer;
iii. from 35 to 100 ppm, preferably from 50 ppm to 75 ppm of an alkoxylated polyamine and/or an alkoxylated polyalkyleneimine polymer; and
iv. optionally from 40 to 150 ppm, preferably from 50 to 125 ppm of a modified hexamethylenediamine.

### Process of Making

Those skilled in the art will be aware of processes to make the detergent composition of the present disclosure. Those skilled in the art will be aware of standard processes and equipment to make the detergent compositions.

Those skilled in the art will be aware of standard techniques to make the unit dose article. Standard forming processes including but not limited to thermoforming and vacuum forming techniques may be used.

A preferred method of making the water-soluble unit dose article according to the present disclosure comprises the steps of moulding a first water-soluble film in a mould to form an open cavity, filling the cavity with the detergent composition, laying a second film over the first film to close the cavity, and sealing the first and second films together preferably through solvent sealing, the solvent preferably comprising water, to produce the water-soluble unit dose article.

### Examples

### Washing Test Method:

A tergotometer was used to simulate the washing of fabrics in a washing machine with the following wash conditions:
Wash cycle: 30° C., 40 min, agitation 300 rpm
Rinse cycle: 2×5 min rinse, 15° C., agitation 208 rpm
Dry cycle: stains are dried for 30 minutes in pre-heated electric dryers at a temperature 60-65° C.
1 litre wash water per wash and rinse cycle (20 gpg water hardness)
60 g load: 6 stained swatches, 11.4 g SBL (soiled ballast load, SBL2004 6×6 cm pre-cut squares, as supplied by WfK Testgewebe GmbH), 42 g ballast load (Knitted cotton fabric, sourced from Equest)
Test compositions and concentrations are shown in Table 2

Table 1 shows the 13 stains tested. The 13 stains are distributed on three 6×6 cm swatches of CW120 (a white 100% cotton interlock double knit fabric, available from Equest). The 9 EQ stains are hand-applied in circles of 1.2 cm diameter across 2 swatches (4 or 5 stains per swatch). The 4 CFT stains are sewn on a 3^{rd} swatch in 3×3 cm squares. 2 of each swatches are added to a test pot.

Stains were imaged pre- and post-washing using Digi Eye Imaging equipment, allowing to calculate a stain removal index (SRI) accordingly (100=full removal, 0=no removal). An average SRI was calculated for each test composition across 8 replicates of each type of stain (2 internal replicates, 4 external replicates-replicates were randomized across test pots over different runs) and consequently across the 13 stain types. The average SRI was consequently referenced versus a chosen test leg indexed at 100.

TABLE 1
stain set (as received from Warwick Equest)

CFT ASTM Dust Sebum PCS94
CFT Choc Soy Milk CS45
CFT Discriminating Sebum PCS132
CFT Rice Starch CS28
EQ Bacon Grease Dyed CW120 GSRTBGD001 - 1
EQ Black Todd Clay CW120 GSRTBT001 - 1
EQ Burnt Butter CW120 GSRTBB001 - 1
EQ Cooked Beef CW120 GSRTCB001
EQ Grass CW120 GSRTGR001
EQ Makeup Covergirl CW120 GSRTCGM001 - 1
EQ Red Wine Wolf Blas CW120 GSRTRW001
EQ Spaghetti Sauce Ragu CW120 GSRTSS002
EQ Tea American Lipton CW120 GSRTLIT001 - 1

### Test Compositions:

Table 2 summarizes the different test compositions. Test compositions were prepared through addition of a stated volume of base 1, base 2, base 3 or base 4 starting formulations as shown in Table 3 and spiking with cleaning additives as shown in Table 4 to the stated amount directly into the wash solution. The resulting dilution factor was 509 ml water/gram detergent.

TABLE 2
Test formulations

| | | | Non-soap |
|---|---|---|---|
| | | Surfactant | surfactant |
| | | through the | through the |
| Composition | Wash solution | wash (ppm) | wash (ppm) |
| Comparative | 1000 ml wash water/ | 895 | 798 |
| example A | 1.96 g base 1 | | |
| Comparative | 1000 ml wash water/ | 497 | 400 |
| example B | 1.96 g base 2 | | |
| Comparative | 1000 ml wash water/ | 497 | 400 |
| example C | 1.96 g base 2 + | | |
| | cleaning additive | | |
| Comparative | 1000 ml wash water/ | 897 | 800 |
| example D | 1.96 g base 3 | | |
| Example 1 | 1000 ml wash water/ | 497 | 400 |
| | 1.96 g base 4 | | |
| Example 2 | 1000 ml wash water/ | 497 | 400 |
| | 1.96 g base 4 + | | |
| | cleaning additive | | |

TABLE 3
starting base formulations

| Wt % (100% active basis) | Base 1 | Base 2 | Base 3 | Base 4 |
|---|---|---|---|---|
| Water | 10.6 | 33.5 | 10.6 | 33.5 |
| Citric acid | 0.7 | 0.7 | 0.7 | 0.7 |
| 1,2-propanediol | 13.8 | 13.8 | 13.8 | 13.8 |
| Monoethanolamine | 10.4 | 7.9 | 10.4 | 7.9 |
| Glycerin | 5.6 | 5.6 | 5.6 | 5.6 |
| HEDP chelant | 2.2 | 2.2 | 2.2 | 2.2 |
| Potassium sulfite | 0.4 | 0.4 | 0.4 | 0.4 |
| Neodol 24/7 nonionic | 3.3 | 1.7 | 14.0 | 7.0 |
| surfactant | | | | |
| HLAS anionic | 26.7 | 13.4 | 26.7 | 13.4 |
| surfactant | | | | |
| Brightener 49 | 0.3 | 0.3 | 0.3 | 0.3 |
| DTPK fatty acid | 5.3 | 5.3 | 5.3 | 5.3 |
| C12-14AE3S anionic | 10.7 | 5.3 | — | 0.0 |
| surfactant | | | | |
| Zwitterionic polyamine¹ | 1.8 | 1.8 | 1.8 | 1.8 |
| Ethoxylated | 1.6 | 1.6 | 1.6 | 1.6 |
| polyethyleneimine² | | | | |
| MgCl² | 0.3 | 0.3 | 0.3 | 0.3 |
| Amphiphilic graft | 2.2 | 2.2 | 2.2 | 2.2 |
| copolymer³ | | | | |
| Antifoam (AF8017) | 0.2 | 0.2 | 0.2 | 0.2 |
| protease (76.3 mg/g) | 0.1 | 0.1 | 0.1 | 0.1 |
| Amylase 1 (29.26 mg/g) | 0.008 | 0.008 | 0.008 | 0.008 |
| Amylase 2 (25.4 mg/g) | 0.002 | 0.002 | 0.002 | 0.002 |
| Mannanase (25 mg/g) | 0.003 | 0.003 | 0.003 | 0.003 |
| nuclease | 0.010 | 0.010 | 0.010 | 0.010 |
| Blue AH global | 0.001 | 0.001 | 0.001 | 0.001 |
| Cyan 15 | 0.006 | 0.006 | 0.006 | 0.006 |
| Yellow PG | 0.001 | 0.001 | 0.001 | 0.001 |
| perfume | 2.0 | 2.0 | 2.0 | 2.0 |
| Hydrogenated castor oil | 0.1 | 0.1 | 0.1 | 0.1 |
| Xyloglucanase (23 | 0.005 | 0.005 | 0.005 | 0.005 |
| mg/g) | | | | |
| Anionic polyester | 0.3 | 0.3 | 0.3 | 0.3 |
| terephthalate⁴ | | | | |
| Hueing dye (Violet 200) | 0.047 | 0.047 | 0.047 | 0.047 |
| Minors | 1.4 | 1.4 | 1.4 | 1.4 |
| Total | 100 | 100 | 100 | 100 |
| pH (10% solution) | 7.4 | 7.4 | 7.4 | 7.4 |
| Anionic (AN)/nonionic | 12.9:1 | 14.1:1 | 2.3:1 | 2.7:1 |
| (NI) surfactant ratio | | | | |
| Non-soap anionic/ | 11.3:1 | 11.3:1 | 1.9:1 | 1.9:1 |
| nonionic surfactant ratio | | | | |

¹Lutensit Z96 (zwitterionic polyamine ex BASF—zwitterionic hexamethylene diamine, 100% quaternized and about 40% of the polyethoxy (EO24) groups are sulfonated), preferably having a structure below). 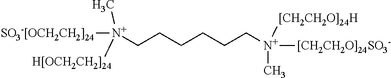
²Lutensol FP620 ex BASF—ethoxylated polyethyleneimine (PEI600 EO20)
³polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
⁴Texcare SRA300 ex Clariant

TABLE 4
cleaning additives

| ppm active TTW | Cleaning additive package |
|---|---|
| Metalloprotease | 0.40 |
| Amylase 1 | 0.14 |
| Xyloglucanase | 0.25 |
| Lipase | 0.35 |
| Zwitterionic polyamine¹ | 72.00 |
| Ethoxylated polyethyleneimine² | 30.00 |
| Amphiphilic graft copolymer³ | 43.00 |
| Anionic polyester terephthalate⁴ | 12.00 |
| HEDP chelant | 35.00 |

### Test Results:

As can be seen from the performance results in Table 5 the stain removal profile of a surfactant system comprising an anionic surfactant to nonionic surfactant ratio (AN/NI-ratio) according to the disclosure is far less sensitive to surfactant level reductions through the wash (TTW) when compared to a surfactant ratio outside the scope of the disclosure. More particularly, while at high surfactant levels TTW an anionic surfactant to nonionic surfactant level outside the scope of the disclosure (comparative composition A) demonstrated a stronger stain removal performance as compared to the ratio according to the disclosure (comparative composition D), upon reduction of the surfactant levels inside the scope of the disclosure (comparative composition B) its performance become strongly compromised, leading to inferior stain removal performance versus related compositions as detailed herein (Example 1). While addition of cleaning additives aided at restoring cleaning performance, superior cleaning performance was observed for the anionic surfactant to nonionic surfactant ratio according to the disclosure (Example 2 versus comparative composition C).

TABLE 5
performance results

| | | Average | SRI |
|---|---|---|---|
| Example | Composition | SRI | Index |
| Comparative | AN/NI-ratio: 12.9:1 - 895 ppm | 60.9 | 100 |
| Example A | TTW surfactant | | |
| Comparative | AN/NI-ratio: 14.1:1-ratio - | 51.2 | 84 |
| Example B | 497 ppm TTW surfactant | | |
| Comparative | AN/NI-ratio: 14.1:1-ratio - | 61.3 | 101 |
| Example C | 497 ppm TTW surfactant + | | |
| | cleaning additives | | |
| Comparative | AN/NI-ratio: 2.3:1 - 897 ppm TTW | 57.4 | 95 |
| Example D | surfactant | | |
| Example 1 | AN/NI-ratio: 2.7:1-ratio - 497 ppm | 55.9 | 92 |
| | TTW surfactant | | |
| Example 2 | AN/NI-ratio: 2.7:1-ratio - 497 ppm | 63.6 | 104 |
| | TTW + cleaning additives | | |

A water-soluble pouch composition suitable for a wash method according to the disclosure includes 25.56 g of the compositions shown in Table 6 wrapped up in a polyvinyl alcohol based water-soluble film.

TABLE 6
unit dose article

Wt % (100% active basis)

| | Composition 3 | Composition 4 |
|---|---|---|
| Water | 11.5 | 11.6 |
| Citric acid | 0.7 | 0.7 |
| 1,2-propanediol | 25.8 | 20.8 |
| Monoethanolamine | 7.9 | 7.9 |
| Glycerin | 15.6 | 10.6 |
| HEDP chelant | 2.2 | 4.0 |
| Potassium sulfite | 0.4 | 0.4 |
| Neodol 24/7 nonionic | 7.0 | 7.0 |
| surfactant | | |
| HLAS anionic | 13.4 | 13.4 |
| surfactant | | |
| Brightener 49 | 0.3 | 0.3 |
| DTPK Fatty acid | 5.3 | 5.3 |
| C12-14AE3S anionic | 0.0 | 0.0 |
| surfactant | | |
| Zwitterionic | 1.8 | 5.5 |
| polyamine1 | | |
| Ethoxylated | 1.6 | 3.2 |
| polyethyleneimine2 | | |
| MgCl2 | 0.3 | 0.3 |
| Amphiphilic graft | 2.2 | 4.4 |
| copolymer³ | | |
| Antifoam (AF8017) | 0.2 | 0.2 |
| protease (76.3 mg/g) | 0.1 | 0.1 |
| Amylase 1 (29.26 | 0.008 | 0.008 |
| mg/g) | | |
| Amylase 2 (25.4 | 0.002 | 0.002 |
| mg/g) | | |
| Mannanase (25 mg/g) | 0.003 | 0.003 |
| nuclease | 0.010 | 0.010 |
| metalloprotease | — | 0.050 |
| lipase | — | 0.050 |
| Blue AH global | 0.001 | 0.001 |
| Cyan 15 | 0.006 | 0.006 |
| Yellow PG | 0.001 | 0.001 |
| perfume | 2.0 | 2.0 |
| Hydrogenated castor | 0.1 | 0.1 |
| oil | | |
| Xyloglucanase (23 mg/g) | 0.005 | 0.005 |
| Anionic polyester | 0.3 | 0.9 |
| terephthalate⁴ | | |
| Hueing dye (Violet 200) | 0.047 | 0.047 |
| Minors | 1.4 | 1.4 |
| Total | 100 | 100 |
| pH (10% solution) | 7.4 | 7.4 |

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to anything disclosed or claimed herein or that it alone, or in any combination with any other reference or references, teaches, suggests or discloses anything disclosed or claimed herein. Further, to the extent that any meaning or definition of a term in this document conflicts with any meaning or definition of the same term in a document incorporated by reference, the meaning or definition assigned to that term in this document shall govern.

While particular forms of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A method of laundering a fabric in an automatic washing machine using a water-soluble unit dose article comprising a detergent composition and a water-soluble film, the detergent composition comprising a surfactant system comprising an anionic surfactant and a nonionic surfactant in a weight ratio of from about 4:1 to about 1:2 and a cleaning additive selected from the group consisting of a cleaning polymer, a zwitterionic polyamine, an enzyme system, a chelant, and a mixture thereof, the method comprising the steps of:
a. delivering the water-soluble unit dose article to the washing machine;
b delivering water to the washing machine to release the detergent composition and to achieve a water/detergent dilution of from about 200 to about 700 ml water/g detergent, to create a wash liquor comprising from about 400 to about 700 ppm of total surfactant;
c. exposing the fabric to the wash liquor resulting from step b; and
d. rinsing the fabric; and
e. drying the fabric.

2. The method according to claim 1, wherein the surfactant system comprises a non-soap surfactant system comprising a non-soap anionic surfactant and a nonionic surfactant in a weight ratio of from about 3:1 to 1:2 and wherein the wash liquor comprises from about 300 to about 600 ppm of total non-soap surfactant.

3. The method according to claim 1, wherein the detergent composition comprises a cleaning polymer and the cleaning polymer comprises at least one polymer and at least two polymers selected from the group consisting of a graft polymer, a modified polyamine polymer, a polyester soil release polymer and a polysaccharide-based polymer.

4. The method according to claim 1, wherein the wash liquor resulting from step (b) comprises from about 100 to about 300 ppm of the cleaning polymer.

5. The method according to claim 1, wherein the non-soap surfactant system and the cleaning polymer are present in the wash liquor resulting from step b. in a weight ratio of from 1.5:1 to 8:1.

6. The method according to claim 1, wherein the wash liquor resulting from step (b) comprises from about 50 to about 150 ppm of the zwitterionic polyamine, of a zwitterionic hexamethylenediamine.

7. The method according to claim 1, wherein the wash liquor resulting from step (b) comprises from about 2 to about 10 ppm on active protein basis of the enzyme system and the enzyme system comprises two or more enzymes selected from the group consisting of protease, metalloprotease, amylase, cellulase, lipase, hexosaminidase, DNA'ase, pectate lyase and xyloglucanase.

8. The method according to claim 1, wherein the wash liquor resulting from step (b) comprises from about 50 to about 200 ppm of the chelant, wherein the chelant is selected from an aminocarboxylate and/or an aminophosphonate chelant.

9. The method according to claim 1, wherein the wash liquor resulting from step (b) comprises:
i. from about 100 to about 300 ppm of the cleaning polymer;
ii. optionally from about 40 to about 150 ppm of the zwitterionic polyamine, a modified zwitterionic hexamethylenediamine;
iii. from about 2 to about 5 ppm on active protein basis of the enzyme system; and
iv. from about 50 to about 100 ppm of the chelant.

10. The method according to claim 1, wherein the wash liquor resulting from step (b) comprises:
i. from about 8 to about 30 ppm of a polyester terephthalate;
ii. ii. from about 50 to about 150 ppm of an amphiphilic graft co-polymer;
iii. from about 35 to about 100 ppm of an alkoxylated polyamine and/or an alkoxylated polyalkyleneimine polymer; and
iv. optionally from about 50 to about 125 ppm of a zwitterionic hexamethylenediamine.

11. The method according to claim 1, wherein the anionic surfactant is selected from the group consisting of linear alkyl benzene sulphonate, alkyl ether sulphate, alkyl sulphate, fatty acid salts, and mixtures thereof and wherein the nonionic surfactant is selected from the group consisting of linear or branched primary alcohol alkoxylate, secondary alcohol alkoxylate, and mixtures thereof.

12. The method according to claim 1, comprising a cleaning polymer wherein the cleaning polymer comprises a polyester terephthalate that is a polyester terephthalate backbone optionally grafted with one or more anionic groups and wherein the polyester terephthalate comprises a combination of the structural units (I) to (III): 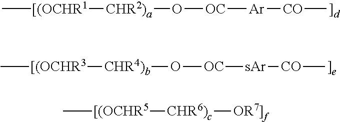
wherein:
a, b and c are from 1 to 200;
d, e and f are from 1 to 50;
Ar is a 1,4-substituted phenylene;
sAr is 1,3-substituted phenylene substituted in position 5 with SO3Me;
Me is Li, K, Mg/2, Ca/2, Al/3, ammonium, mono-, di-, tri-, or
tetraalkylammonium wherein the alkyl groups are (C1-C22)alkyl or (C2-C10) hydroxyalkyl, or mixtures thereof;
R1, R2, R3, R4, R5 and R6 are independently selected from H or (C1-C18) n- or iso-alkyl methyl; and R7 is a linear or branched (C1-C18) alkyl, or a linear or branched (C2-C30) alkenyl, or a cycloalkyl group with 5 to 9 carbon atoms, a (C6-C30) aryl group or a (C6-C50) arylalkyl group phenyl or benzyl.
R1 to R6 independently are H or methyl,
R7 is methyl,
a, b and c are a number from 1 to 20,
d is a number between 1 and 25,
e is a number between 1 and 30, and
f is a number between 0.05 and 15.

13. The method according to claim 1, comprising a cleaning polymer wherein the cleaning polymer comprises an amphiphilic graft co-polymer based on water-soluble polyalkylene oxides (A) as a graft base and side chains formed by polymerization of a vinyl ester component (B), said polymer having an average of not more than 0.4 graft site per 50 alkylene oxide units, a polydispersity of less than or equal to 3, and mean molar masses Mw of from about 3000 to about 100 000.

14. The method according to claim 1, wherein the cleaning polymer comprises an alkoxylated polyalkyleneimine polymer, wherein the alkoxylated polyalkyleneimine is selected from an ethoxylated polyethyleneimine wherein;
the polyalkyleneimine polyethyleneimine backbone has a weight average molecular weight of between about 100 g/mol and about 2000 g/mol;
an average of about 5 to about 40, alkoxy units per alkoxylation chain, wherein the alkoxylation chain is an ethoxylation chain;
the alkoxylated polyalkyleneimine ethoxylated polyethyleneimine has a total weight average molecular weight of from about 5000 g/mol to about 20000 g/mol;
wherein the terminal alkoxy, ethoxy moiety of the alkoxylation, ethoxylation modification is capped with hydrogen, a C1-C4 alkyl or mixtures thereof, hydrogen;
the degree of permanent quaternization being from about 0% to about 30% of the polyalkyleneimine polyethyleneimine backbone nitrogen atoms, about 0%. The method according to any of the preceding claims comprising a zwitterionic polyamine wherein the zwitterionic polyamine is a zwitterionic hexamethylenediamine, a quaternized ethoxysulfated hexamethylene diamine, or the quaternized ethoxysulfated hexamethylenediamine selected from compounds of the following general formula

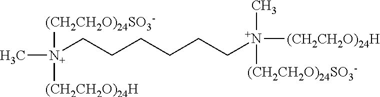

15. The method according to claim 1, wherein the detergent composition further comprises a detergent active selected form the group consisting of builders, including citrate, bleach, bleach catalyst, aesthetic dye, hueing dye, brightener, fabric conditioning polymers including Polyquaternium 10, cationic glucan and cationic polyglucan, further surfactant including amine oxide and solvent, dye transfer inhibitors, perfume, encapsulated perfume, polycarboxylates, structurant, pH trimming agents, antioxidants, preservatives, antibacterial agents including Tinosan HP100 and probiotics, and mixtures thereof.

16. The method according to claim 1, wherein the water-soluble film comprises a water-soluble resin comprising at least one polyvinyl alcohol homopolymer or at least one polyvinylalcohol copolymer, or a blend thereof.

17. The method according to claim 1 wherein said wash step comprises the addition of between about 5 L and about 40 L, to the drum of the automatic washing machine.

18. The method according to claim 1, wherein the water-soluble unit dose article comprises from about 8 to about 40 grams of detergent composition.
